(19) United States
(12) Patent Application Publication
(10) Pub. No.: US 2006/0066010 A1
(43) Pub. Date: Mar. 30, 2006

(54) Method for manufacturing molded product

(75) Inventors: Shigehiro Ueno, Aichi-ken (JP); Hiroshi Mukai, Aichi-ken (JP); Kazumichi Shigeno, Aichi-ken (JP); Koichi Ueno, Aichi-ken (JP); Yoshiaki Shichida, Aichi-ken (JP); Katsutoshi Mizuno, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/229,857

(22) Filed: Sep. 20, 2005

(30) Foreign Application Priority Data
Sep. 24, 2004 (JP) 2004-277507

(51) Int. Cl. B29C 45/00

(52) U.S. Cl. 264/328.1

(57) ABSTRACT

A mold having a molding cavity and a plurality of gates for injecting molding material into the cavity is prepared. The mold has a leakage suppressing portion for suppressing leakage of the molding material to a clearance of the mold. The gates include gates of different distances from the leakage suppressing portion. As the molding material, a material the fluidity of which is a spiral flow length of 20 to 70 cm is prepared. The injection pressure of the molding material from the gates of the different distances from the leakage suppression portion is equalized. The gate that is farther from the leakage suppressing portion is caused to first start injecting the molding material into the molding cavity.

### BACKGROUND OF THE INVENTION

The present invention relates to a method for manufacturing molded products, and particularly to a method for manufacturing molded products such as instrument panels of vehicles.

A molded product such as a vehicle instrument panel includes a base and a skin that covers the base. Typically, a skin is formed on the surface of the base after the base is molded. Specifically, a skin is formed on the base surface with a low flow molding material through powder slush molding, vacuum molding, or spray molding. However, when forming a skin on the surface of a base, the amount of excess molding material is increased during molding. Therefore, in the above listed molding methods, the difference between the necessary amount for molding a skin and the amount of molding material used during molding is great. This reduces yields. That is, these methods are not suitable for increasing the production. As a result, the manufacturing costs are increased.

On the other hand, in the case of injection molding, where molten resin is injected into a cavity defined in a mold, the difference between the necessary amount of the molding material and the used amount of the molding material is small. This permits yield to be increased. As a result, the production is increased. However, in the injection molding, a high-flow molding material needs to be used so that the molding material fills the cavity without voids. Further, the molding material needs to be injected in to the cavity at a predetermined injection pressure. Therefore, in the case of the injection molding, molding material leaks to clearance between contacting surfaces of the mold (parting line surface). This is likely to create excess portions due to leaking, or flash. Accordingly, a process for removing the flash needs to be provided after injection molding, which may lower the productivity.

As a countermeasure against the formation of flash, Japanese Laid-Open Patent Publication No. 5-345342 discloses a method for setting conditions of injection molding. This method reduces the thickness of flash using the correlation between molding conditions that affect the flash thickness and the degree of mold opening. Also, Japanese Laid-Open Utility Model Publication No. 6-64837 discloses a molding apparatus for synthetic resin bumpers, which apparatus needs no step for removing flash. Specifically, the apparatus causes flash to be formed at the side surfaces of lamp accommodating recesses, so that side marker lamps attached to the recesses conceal the flash.

The quality requirements for the texture and appearance of molded products such as instrument panel are increased year by year. Particularly, in addition to quality features such as texture and appearance, a skin forming the outer surface of a molded product needs to be thin and durable. In the case where a skin is molded through injection molding, conventional molding material such as polypropylene and ABS presented in Japanese Laid-Open Patent Publication No. 5-345342 cannot satisfy the required standards. It is therefore necessary to use molding material having a higher flow than conventional molding material. Most recent molded products such as instrument panels employ a flush surface structure in which the surface is substantially flush to improve the appearance. In such molded products, the skin, which is visible to users, is desired to have minimized steps and clearances between the product and other attached accessories. Therefore, unlike the case presented in Japanese Laid-Open Utility Model Publication No. 6-64837, it is therefore difficult to conceal flash with accessories. Thus, the methods and apparatus disclosed in Japanese Laid-Open Patent Publication No. 5-345342 and Japanese Laid-Open Utility Model Publication No. 6-64837 are inadequate as countermeasures against flash. As a result, methods for injection molding the skin of molded products still have problems of reduced productivity due to the formation of flash.

### SUMMARY OF THE INVENTION

Accordingly, it is an objective of the present invention to provide a method for manufacturing molded product that improves productivity as well as yields.

To achieve the foregoing and other objectives and in accordance with the purpose of the present invention, a method for manufacturing a molded product is provided. The method includes: preparing a mold having a molding cavity and a plurality of gates for injecting molding material into the cavity, wherein the mold has a leakage suppressing portion for suppressing leakage of the molding material to a clearance of the mold, and wherein the gates include gates of different distances from the leakage suppressing portion; preparing, as the molding material, a material the fluidity of which is a spiral flow length of 20 to 70 cm; and equalizing the injection pressure of the molding material from the gates of the different distances from the leakage suppression portion, and causing the gate that is farther from the leakage suppressing portion to first start injecting the molding material into the molding cavity.

The present invention provides another method for manufacturing a molded product. The method includes: preparing a mold having a molding cavity and a plurality of gates for injecting molding material into the cavity, wherein the mold has a leakage suppressing portion for suppressing leakage of the molding material to a clearance of the mold, and wherein the gates include gates of the same distances from the leakage suppressing portion; preparing, as the molding material, a material the fluidity of which is a spiral flow length of 20 to 70 cm; and unequalizing the injection pressure of the molding material from the gates of the same distances from the leakage suppression portion, and causing the gate of the higher injection pressure to first start injecting the molding material into the molding cavity.

Further, the present invention provides yet another method for manufacturing a molded product. The method includes: preparing a mold having a molding cavity and a plurality of gates for injecting molding material into the cavity, wherein the mold has a leakage suppressing portion for suppressing leakage of the molding material to a clearance of the mold, and wherein the gates include gates of different distances from the leakage suppressing portion and gates of different injection pressures of the molding material; preparing, as the molding material, a material the fluidity of which is a spiral flow length of 20 to 70 cm; and causing, with regard to the gates of the different distances from the leakage suppression portion, the gate that is farther from the leakage suppressing portion to first start injecting the molding material into the molding cavity; and causing, with regard to the gates of the different injection pressures, the gate of the higher injection pressure to first start injecting the molding material into the molding cavity.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view illustrating an instrument panel according to a first embodiment of the present invention;

FIG. 2 is a cross-sectional view taken along line 2-2 of FIG. 1;

FIG. 3 is a flowchart showing processes for manufacturing the instrument panel shown in FIG. 1;

FIG. 4A is a partial cross-sectional view illustrating a mold for molding a skin, when the mold is clamped;

FIG. 4B is a partial cross-sectional view illustrating a state in which a skin material has been injected into a skin molding cavity;

FIG. 5A is a partial cross-sectional view illustrating a mold for molding a skin according to a second embodiment of the present invention, when the mold is clamped;

FIG. 5B is a partial cross-sectional view illustrating a state in which a skin material has been injected into a skin molding cavity according to the second embodiment;

FIG. 6A is a partial cross-sectional view illustrating a mold for molding a skin according to a third embodiment of the present invention, when the mold is clamped; and

FIG. 6B is a partial cross-sectional view illustrating a state in which a skin forming material has been injected into a skin forming cavity according to the third embodiment.

### DETAILED DESCRIPTION OF THE PREFERRED EMBODIMENTS

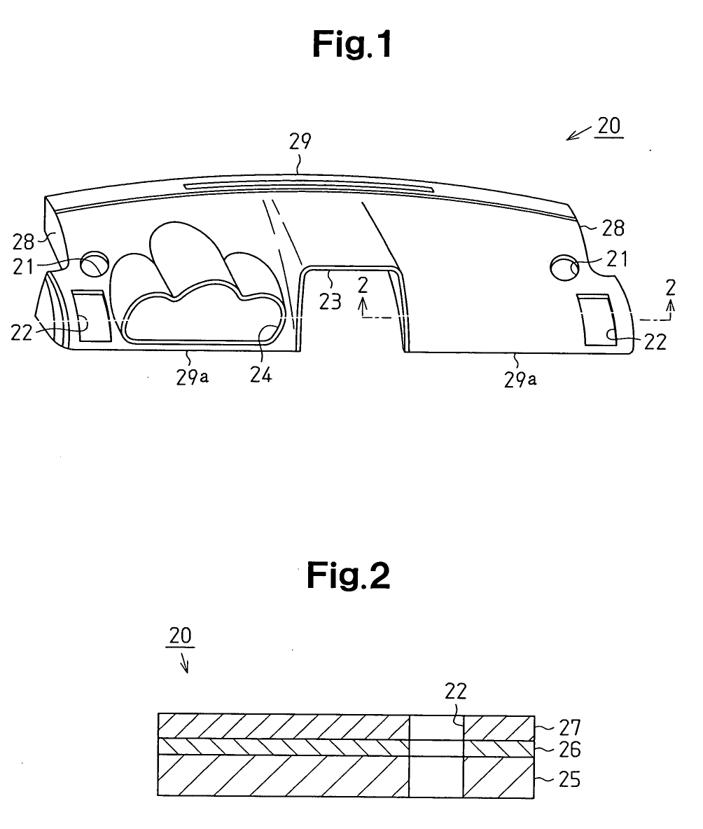

An instrument panel of an automobile according to a first embodiment of the present invention will now be described with reference to FIGS. 1 to 4B. In the following, the traveling direction of the vehicle is referred to as forward direction. Also, unless specified otherwise, a vertical direction and a lateral direction are the same as the vertical direction and the lateral direction of the vehicle.

As shown in FIG. 1, an instrument panel 20 is a generally rectangular molded product. A side defroster opening 21 and a side register opening 22 are formed in each of side portions of the instrument panel 20. A recess 23 for receiving a center cluster (not shown) is formed in a center portion of the instrument panel 20. To the left of the recess 23, an opening 24 for receiving a meter cluster (not shown) is formed. The side defroster openings 21 and the side register openings 22 are holes to which outlet grilles are attached. The outlet grilles, the center cluster, and the meter cluster are accessories attached to the instrument panel 20.

As shown in FIG. 2, the instrument panel 20 has a three-layer structure having a base 25 made of thermoplastic resin, a polyurethane resin layer 26 formed on the base 25, and a skin 27 formed on the polyurethane resin layer 26. The skin 27 is formed of thermoplastic olefin (TPO). The base 25, the polyurethane resin layer 26, and the skin 27 are each formed by injection molding.

The instrument panel 20 is installed in the front end portion of a passenger compartment (not shown). When installed in the passenger compartment, the instrument panel 20 has several portions that are covered by walls of the passenger compartment or the accessories and cannot be seen from the outside. More specifically, these portions of the instrument panel 20 include left and right side wall portions 28, a front wall portion 29, portions defining the recess 23, and portions defining the opening portion 24. The formation of flash in these portions does not degrade the appearance. Also, these portions do not need to be flush with other parts or accessories with a high accuracy. Therefore, such portions are referred to as flash permitting portions in which the formation of flash is permitted when injection molding the skin 27. Flash is a general term for excess portions that are formed by leakage of molding material into clearances in a mold.

Besides the flash permitting portions, the instrument panel 20 installed in the passenger component has several portions where the formation of flash needs to be suppressed. This because other parts or accessories are attached to some of these portions to form flush surfaces with a high accuracy, and some of these portions are visible from the outside. For example, a glove box and a lower cover are attached to a lower end portion 29a of the instrument panel 20 to form flush surface with a high accuracy. The outlet grilles are installed in the side defroster openings 21 and the side register openings 22 to form flush surfaces with a high accuracy. Further, the lower end portion 29a, the side defroster openings 21, and the side register openings 22 are located in positions visible from the outside even if other parts or accessories are attached thereto. Therefore, the lower end portion 29a, the portions defining the side defroster openings 21, the portions defining the side register opening 22 are referred to as flash suppressing portions (excess suppressing portions), where the formation of flash needs to be suppressed when injection molding the skin 27. If flash is formed in the flash suppressing portions of the skin 27, the appearance is degraded and other parts cannot be attached to form flush surfaces with a high accuracy.

The method for manufacturing the instrument panel 20 will now be described.

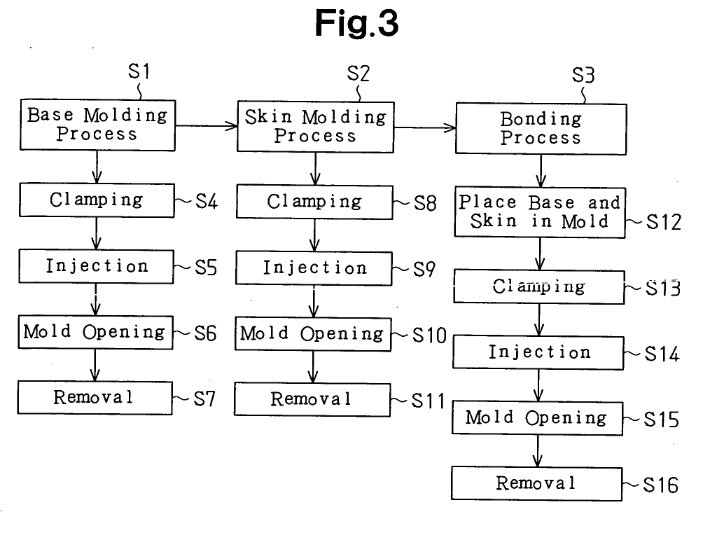

As shown in FIG. 3, the instrument panel 20 is manufactured through a base molding process (step S1) for molding the base 25, a skin molding process (step S2) or molding the skin 27, and a bonding process (step S3) for bonding the skin 27 onto the base 25.

In the base molding process (step S1), a fixed mold member and a movable mold member (neither is shown) for molding the base 25 are clamped so that a cavity (not shown) for molding the base 25 is defined (step S4). Subsequently, molten thermoplastic resin is injected into the base molding cavity through gates (not shown), so that the resin fills the base molding cavity. The resin is then caused to solidity (step S5). Thereafter, the base molding fixed mold member and the movable base mold member are opened (step S6). Then, the base 25 is removed from the movable base mold member (step S7).

A skin mold 30 used for molding the skin 27 in a skin molding process (step S2) will now be described.

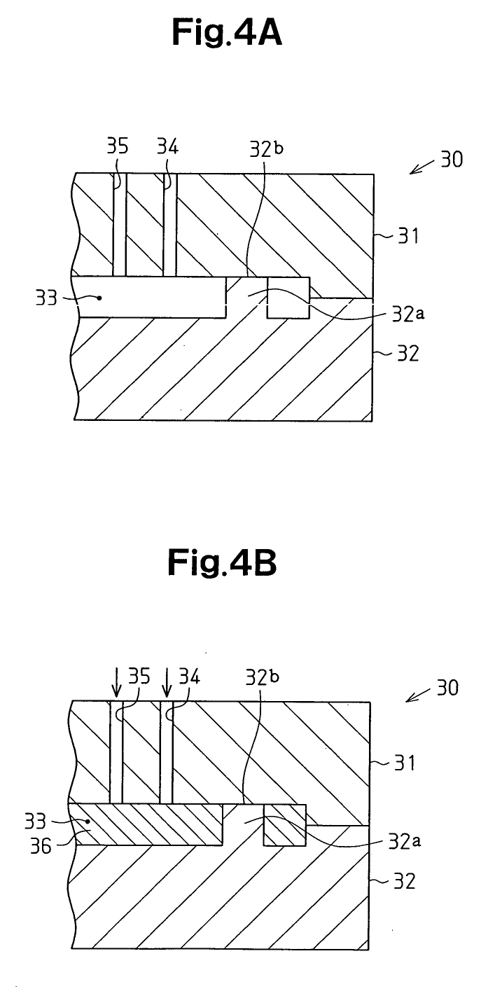

As shown in FIGS. 4A, 4B, the skin mold 30 for molding the skin 27 includes a fixed skin mold member 31 and a movable skin mold member 32. The fixed skin mold member 31 and the movable skin mold member 32 are clamped so that a skin molding cavity 33 is defined in the skin mold 30. A pair of projections 32a (only one is shown in FIG. 2) for forming the side register openings 22 are formed on the cavity surface of the skin forming movable mold member 32.

The skin mold 30 has a clearance at contacting portions of the fixed skin mold member 31 and the movable skin mold member 32. When injecting a skin material 36 into the skin molding cavity 33, leakage of the skin material 36 into the clearance results in the formation of flash on the skin 27. Corresponding to the flash permitting portions and the flash suppressing portions of the skin 27, the skin mold 30 has leaking permitting portions that permit the skin material 36 to leak from the skin molding cavity 33, and leakage suppressing portions that prevent the skin material 36 from leaking from the skin molding cavity 33. In this embodiment, among the portions for molding the side register openings 22, which are flash suppressing portions, portions at which the skin material 36 is likely to leak, that is, a contacting portion 32b at which the cavity surface of the fixed skin mold member 31 contacts the projection 32a in FIGS. 4A and 4B functions as a leakage suppressing portion. In the following, the contacting portion 32b is assumed to function as a leakage suppressing portion.

The fixed skin mold member 31 has a first gate 34 and a second gate 35 for injecting the skin material 36 into the skin molding cavity 33. When the distance from the first gate 34 to the contacting portion 32b is compared with the distance from the second gate 35 to the contacting portion 32b, the second gate 35 is farter from the contacting portion 32b than the first gate 34 is from the contacting portion 32b. Although the first and second gates 34, 35 appear on the same cross section as the contacting portion 32b in FIGS. 4 A and FIG. 4 B, the first and second gates 34, 35 are actually displaced from the contacting portion 32b in a direction perpendicular to the surface of the sheets of the drawings such that the first and second gates 34, 35 are sufficiently separated from the contacting portion 32b. Also, in this embodiment, the injection pressure of the skin material injected into the skin molding cavity 33 is the same between the first gate 34 and the second gate 35.

The skin molding process (step 2) shown in FIG. 3 will now be described. In the skin molding step, the fixed skin mold member 31 and the movable skin mold member 32 are clamped as shown in FIG. 4A, so that the skin molding cavity 33 is defined (step S8). Subsequently, as shown in FIG. 4 B, the skin material 36 is injected into the skin molding cavity 33 through the first gate 34 and the second gate 35, so that the skin material 36 fills the skin molding cavity 33. The skin material 36 is then caused to solidify (step S9). Thereafter, the fixed skin mold member 31 and the movable skin mold member 32 are opened (step S10). Then, the skin 27 is removed from the movable skin mold member 32 (step S11).

In process S9, where the skin material 36 fills the cavity 33 and solidifies, first the skin material 36 is injected from the second gate 35. Then, the skin material 36 is injected from the first gate 34. Among the streams of the skin material 36 in the skin molding cavity 33, a stream from the second gate 35 to the contacting portion 32b, which is a leakage suppressing portion, first defined. Thereafter, this first defined stream will be the mainstream. The skin material 36 that is injected from the second gate 35 primarily reaches the contacting portion 32b.

The skin material 36 that flows along the stream from the second gate 35 to the contacting portion 32b loses its momentum at the injection as the flow approaches the contacting portion 32b. After the first gate 34 starts injecting the skin material 36, the skin material 36 that flows from the second gate 35 to the contacting portion 32b is interfered with the skin material 36 injected by the first gate 34. The momentum of the skin material 36 at the injection from the second gate 35 is thus further reduced. The skin material 36 reaches the contacting portion 32b with the reduced momentum, and thus applies slight pressure on the contacting portion 32b. Therefore, the skin material 36 scarcely enters the contacting portion 32b. In addition, the skin material 36 that reaches the contacting portion 32b with the reduced momentum starts solidifying without entering the contacting portion 32b. The skin material 36 therefore seals the contacting portion 32b and prevents the skin material 36 that subsequently reaches the contacting portion 32b from entering the contacting portion 32b.

As the skin material 36, a material having a fluidity of spiral flow length of 20 to 70 cm (measurement conditions: the temperature of the resin is 200 degrees Celsius; the internal die pressure is 10 to 60 MPa; and the diameter of the spiral cavity of the test mold is 10 mm) is used. If the spiral flow length is longer than 70 cm, the skin material 36 is likely to enter the contacting portion 32b from the skin molding cavity 33. In other words, flash tends to be formed at the side register opening 22, which is a flash suppressing portion of the skin 27. If the spiral flow length is less than 20 cm, time necessary for filling the skin molding cavity 33 with the skin material 36 is extended. This may result in insufficient filling and thus reduce the yields of the skin 27. Specific examples of the skin material 36 include TPO and polyvinyl chloride (PVC).

In the bonding process (step S3) shown in FIG. 3, a fixed bonding mold member and a movable bonding mold member (neither is shown) for bonding the base 25 and the skin 27 are opened. The base 25, which has been completed in the base molding process (step S1) is placed on a cavity surface of the movable bonding mold member, and the skin 27, which has been completed in the skin molding process (step S2), is placed on a cavity surface of the fixed bonding mold member (step S12). Subsequently, the fixed bonding mold member and the movable bonding mold member are clamped (step S13). At this time, in a bonding cavity (not shown) defined by the fixed bonding mold member and the movable bonding mold member, a clearance exists between the base 25 and the skin 27. Then, polyurethane resin is injected into this clearance from a gate (not shown) to fill the clearance (step S14). As the injected polyurethane resin solidifies, the base 25 and the skin 27 are bonded to each other by the bonding effect of the polyurethane resin. Accordingly, the polyurethane resin layer 26 is formed between the base 25 and the skin 27, and the instrument panel 20 is completed. Thereafter, the fixed bonding mold member and the movable bonding mold member are opened (step S15). Then, the instrument panel 20 is removed from the movable bonding mold member (step S16).

The first embodiment has the following advantages.

In the skin molding process, the skin material 36 is first injected from the second gate 35, which is located at a position farther from the contacting portion 32b, which is a leakage suppressing portion, before the skin material 36 is injected from the first gate 34, which is located at a position closer to the contacting portion 32b. The skin material 36 injected from the second gate 35 and the skin material 36 injected from the first gate 34 interfere with each other so that the momentum of the skin material 36 at the injection is reduced. Since the skin material 36 reaches the contacting portion 32b with the reduced momentum, the pressure of the skin material 36 applied to the contacting portion 32b is reduced. Therefore, the skin material 36 is prevented from flowing into the contacting portion 32b from the skin molding cavity 33. Thus, even if a high-flow material is used as the skin material 36, the formation of flash is suppressed.

The leakage suppressing portions and the leakage permitting portions are provided in the mold 30 such that, after installing the instrument panel 20 in the passenger compartment, the flash suppressing portions of the skin 27 are located at positions visible from the outside or positions to which other parts are attached with a high accuracy, and the flash permitting portions of the skin 27 are located at positions invisible from the outside or positions to which other parts do not need to be attached with a high accuracy. This eliminates the necessity for flash removing in a subsequent step.

Since the skin material 36 having a relatively high fluidity of a spiral flow length of 20 to 70 cm is injected to mold the skin 27, the skin material 36 is spread to the entire skin molding cavity 33 in a short time. As a result, without using powder slush molding, vacuum molding, or spray molding, skins can be molded by injection molding while suppressing the formation of flash. Thus, the productivity of the skin 27, in other words, the productivity of the instrument panel 20, is improved while improving the yields.

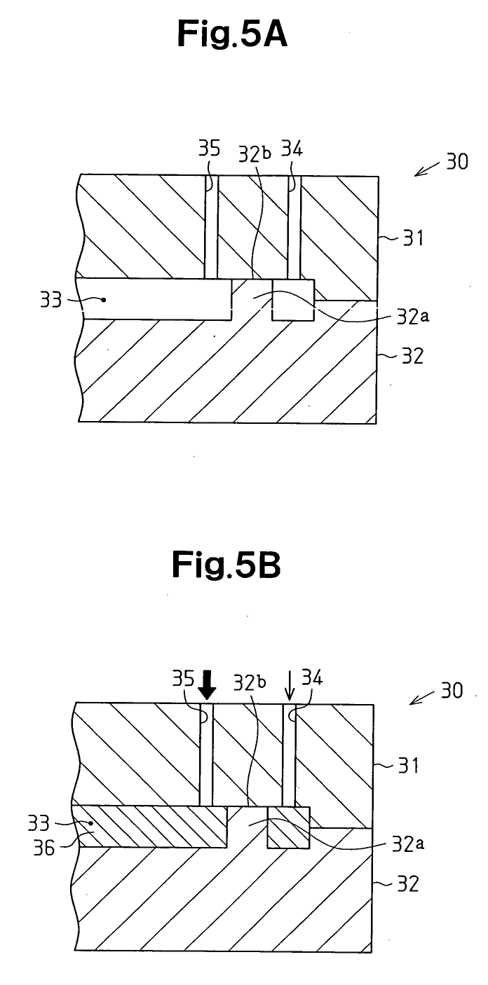

A second embodiment of the present invention will now be described with reference to FIGS. 5A and 5B. The differences from the first embodiment will mainly be discussed below.

As shown in FIG. 5A, a first gate 34 and a second gate 35 are formed in a fixed skin mold member 31 of a skin mold 30 of this embodiment in such a manner that the distance from the first gate 34 to a contacting portion 32b is equal to the distance from the second gate 35 to the contacting portion 32b. Also, in the molding according this embodiment, the injection pressure of the skin material 36 from the first gate 34 is lower than the injection pressure of the skin material 36 from the second gate 35.

As shown in FIG. 5B, in a process where the skin material 36 fills a skin molding cavity 33 and solidifies, the skin material 36 is first injected from the second gate 35. Then, the skin material 36 is injected from the first gate 34. Accordingly, the skin material 36 that is injected from the second gate 35 reaches the contacting portion 32b first. The skin material 36 that flows from the second gate 35 to the contacting portion 32b loses its injection pressure as the flow approaches the contacting portion 32b. That is, the pressure of the skin material 36 is lowered. After the skin material 36 is injected from the first gate 34, the skin material 36 injected from the second gate 35 is interfered with the skin material 36 injected from the first gate 34. This further reduces the pressure of the skin material 36 injected from the second gate 35. The skin material 36 reaches the contacting portion 32b with the reduced pressure, and is unlikely to enter the contacting portion 32b. In addition, the skin material 36 that reaches the contacting portion 32b with the reduced pressure starts solidifying without entering the contacting portion 32b. The skin material 36 therefore seals the contacting portion 32b and prevents the skin material 36 that subsequently reaches the contacting portion 32b from entering the contacting portion 32b.

In the skin molding process according to this embodiment, since the skin material 36 is injected from the second gate 35 of a higher injection pressure before the skin material 36 is injected from the first gate 34 of a lower injection pressure, the pressure of the skin material 36 reaching the contacting portion 32b is reduced. Accordingly, the skin material 36 is prevented from flowing into the contacting portion 32b. As a result, this embodiment provides the same advantages as the first embodiment.

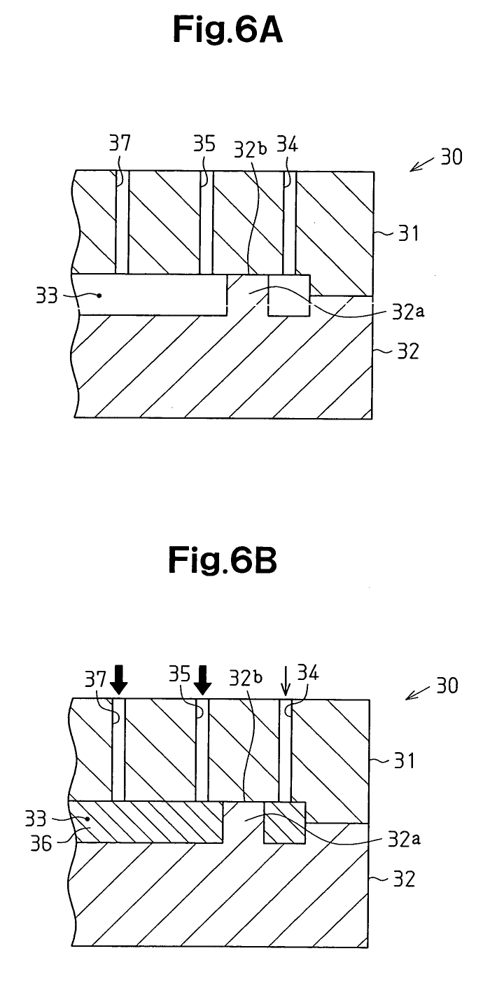

A third embodiment of the present invention will now be described with reference to FIGS. 6A and 6B.

As shown in FIG. 6A, a first gate 34 and a second gate 35 in a skin mold 30 of this embodiment are formed in a fixed skin mold member 31 such that the distances from the contacting portion 32b are the same. Further, a third gate 37 is formed in the fixed skin mold member 31 at a position that is farter from the contacting portion 32b than the first gate 34 and the second gate 35 are from the contacting portion 32b. In the molding according to this embodiment, the injection pressure of the skin material 36 from the first gate 34 is set lower than the injection pressure of the skin material 36 from the second gate 35. Also, the injection pressure of the skin material 36 from the third gate 37 is set equal to the injection pressure of the skin material 36 from the second gate 35.

As shown in FIG. 6B, in a process where the skin material 36 fills a skin molding cavity 33 and solidifies, the skin material 36 is first injected from the third gate 37. Then, the skin material 36 is injected from the second gate 35. Finally, the skin material 36 is injected from the first gate 34. The skin material 36 that is injected from the third gate 37 reaches the contacting portion 32b first. The skin material 36 that flows from the third gate 37 to the contacting portion 32b loses its momentum at the injection and injection pressure as the flow approaches the contacting portion 32b. That is, the flow rate and the pressure of the skin material 36 are lowered. After the skin material 36 is injected from the second gate 35 and the first gate 34, the skin material 36 injected from the third gate 37 is interfered with the skin material 36 injected from the first and second gates 34, 35. This further reduces the flow rate and the pressure of the skin material 36 injected from the third gate 37. The skin material 36 reaches the contacting portion 32b with the reduced flow rate and pressure, and is unlikely to enter the contacting portion 32b. In addition, the skin material 36 that reaches the contacting portion 32b with the reduced flow rate and pressure starts solidifying without entering the contacting portion 32b. The skin material 36 therefore seals the contacting portion 32b and prevents the skin material 36 that subsequently reaches the contacting portion 32b from entering the contacting portion 32b.

In the skin molding process of this embodiment, since the skin material 36 is first injected from the third gate 37 of a higher injection pressure, which is relatively far from the contacting portion 32b, the flow rate and pressure of the skin material 36 reaching the contacting portion 32b are reduced. Accordingly, the skin material 36 is prevented from entering the contacting portion 32b. As a result, this embodiment provides the same advantages as the first embodiment.

The above embodiment may be modified as follows.

Other than the instrument panel 20, the method for manufacturing molded products of any of the above embodiments may be applied to various types of interior parts of vehicle such as console side pads. In this case, leakage suppressing portions and leakage permitting portions need to be appropriately set in accordance with flash suppressing portions and flash permitting portions of the molded product.

The present examples and embodiments are to be considered as illustrative and not restrictive and the invention is not to be limited to the details given herein, but may be modified within the scope and equivalence of the appended claims.

1. A method for manufacturing a molded product, comprising:
preparing a mold having a molding cavity and a plurality of gates for injecting molding material into the cavity, wherein the mold has a leakage suppressing portion for suppressing leakage of the molding material to a clearance of the mold, and wherein the gates include gates of different distances from the leakage suppressing portion;
preparing, as the molding material, a material the fluidity of which is a spiral flow length of 20 to 70 cm; and
equalizing the injection pressure of the molding material from the gates of the different distances from the leakage suppression portion, and causing the gate that is farther from the leakage suppressing portion to first start injecting the molding material into the molding cavity.

2. The method according to claim 1, wherein the fluidity of the molding material is measured under the following conditions:
the temperature of the molding material is 200 degrees Celsius;
the internal die pressure is 10 to 60 MPa; and
the diameter of the spiral cavity of the test mold is 10 mm.

3. The method according to claim 1, wherein the molded product is a skin of a molded product having a base and the skin, the method further comprising molding the base, and boding the skin onto the base.

4. A method for manufacturing a molded product, comprising:
preparing a mold having a molding cavity and a plurality of gates for injecting molding material into the cavity, wherein the mold has a leakage suppressing portion for suppressing leakage of the molding material to a clearance of the mold, and wherein the gates include gates of the same distances from the leakage suppressing portion;
preparing, as the molding material, a material the fluidity of which is a spiral flow length of 20 to 70 cm; and
unequalizing the injection pressure of the molding material from the gates of the same distances from the leakage suppression portion, and causing the gate of the higher injection pressure to first start injecting the molding material into the molding cavity.

5. The method according to claim 4, wherein the fluidity of the molding material is measured under the following conditions:
the temperature of the molding material is 200 degrees Celsius;
the internal die pressure is 10 to 60 MPa; and
the diameter of the spiral cavity of the test mold is 10 mm.

6. The method according to claim 4, wherein the molded product is a skin of a molded product having a base and the skin, the method further comprising molding the base, and boding the skin onto the base.

7. A method for manufacturing a molded product, comprising:
preparing a mold having a molding cavity and a plurality of gates for injecting molding material into the cavity, wherein the mold has a leakage suppressing portion for suppressing leakage of the molding material to a clearance of the mold, and wherein the gates include gates of different distances from the leakage suppressing portion and gates of different injection pressure of the molding material;
preparing, as the molding material, a material the fluidity of which is a spiral flow length of 20 to 70 cm; and
causing, with regard to the gates of the different distances from the leakage suppression portion, the gate that is farther from the leakage suppressing portion to first start injecting the molding material into the molding cavity; and
causing, with regard to the gates of the different injection pressure, the gate of the higher injection pressure to first start injecting the molding material into the molding cavity.

8. The method according to claim 7, further comprising equalizing the injection pressure of the molding material from the gates of the different distances from the leakage suppression portion.

9. The method according to claim 7, wherein the gates of the different injection pressure are at the same distance from the leakage suppression portion.

10. The method according to claim 7, wherein the fluidity of the molding material is measured under the following conditions:
the temperature of the molding material is 200 degrees Celsius;
the internal die pressure is 10 to 60 MPa; and
the diameter of the spiral cavity of the test mold is 10 mm.

11. The method according to claim 5, wherein the molded product is a skin of a molded product having a base and the skin, the method further comprising molding the base, and boding the skin onto the base.
